(19) United States
(12) Patent Application Publication
(10) Pub. No.: US 2013/0332963 A1
(43) Pub. Date: Dec. 12, 2013

(54) METHOD AND SYSTEM FOR CONTROLLING A TELEVISION CONTROL DEVICE, AND TELEVISION CONTROL DEVICE

(71) Applicant: QUATIUS LIMITED, Hong Kong (CN)

(72) Inventor: Ka Wing CHEUNG, Hong Kong (CN)

(73) Assignee: Quatius Limited, Hong Kong (CN)

(21) Appl. No.: 13/840,157

(22) Filed: Mar. 15, 2013

(30) Foreign Application Priority Data
Jun. 12, 2012 (CN) 201210192297.7

(51) Int. Cl. H04N 21/4722

(52) U.S. Cl. CPC H04N 21/4722
USPC 725/51

(57) ABSTRACT

A method and system for controlling a television control device, and a television control device are provided. The method includes the following steps: capturing a preset data link tag from the television video data when receiving a data acquisition instruction; wherein, the data link tag records the data link of network resource data corresponding to the television video data; analyzing the data link tag to obtain the data link; accessing network to obtain corresponding network resource data according to the data link. The method and system for controlling a television control device in the present invention are applicable for various television control devices, like a set-top box, a TV box, etc., and enable a user to obtain the television video easily without having to remember the television video content or website in order to search it on the Internet. This is very simple and convenient in operation.

### FIELD OF THE INVENTION

The present invention relates to the field of the television control device, and in particular to a method for controlling a television control device, and a system for controlling a television control device, and a television control device.

### BACKGROUND OF THE INVENTION

Generally, during the playing of television video, a user who is interested in the content of the television video (including advertisement) and intends to obtain the corresponding information of the television video has to search on the Internet to obtain this video. However, it is troublesome for the user to remember the content of the television video and then search it on the Internet. Especially, for a user who is not familiar with the Internet, it will be very difficult for him.

Therefore, even if a user is interested in the television video content, the user may skip it due to not knowing how to obtain the content of the television video or the time consuming to give up TV enjoy and go to the computer or mobile.

### SUMMARY OF THE INVENTION

In consideration of the above-stated problems in the prior art, it is an object of the present invention to provide a method for controlling a television control device, which enables a user to obtain the television video easily through various television control devices such as a set-top box, a TV box, etc, without having to remember the television video content or website in order to search it on the Internet.

According to one aspect of the invention, a method for controlling a television control device comprises the follow steps:

capturing a preset data link tag from the television video data when receiving a data acquisition instruction, the data link tag recording the data link of network resource data corresponding to the television video data;

analyzing the data link tag to obtain the data link; and

accessing network to obtain corresponding network resource data according to the data link.

In consideration of the above-stated problems in the prior art, it is a further object of the present invention to provide a system for controlling a television control device, and a television control device comprising the controlling system, both of which enable a user to obtain the television video easily through television control device, like a set-top box, a TV box, etc.

The system for controlling a television control device comprises:

a tag acquisition module, configured to capture a preset data link tag from the television video data when receiving a data acquisition instruction; wherein, the data link tag records the data link of network resource data corresponding to the television video data;

an analysis module, configured to analyze the data link tag to obtain the data link; and

a network resource acquisition module, configured to access network to obtain corresponding network resource data according to the data link.

The television control device comprises the system for controlling a television control device.

The method and system for controlling a television control device in the present invention are applicable for all types of television control devices, like a set-top box, a TV box, etc. If a user is interested in a television video when watching television, he may trigger the data acquisition instruction for acquiring the television video by a button on the television remote controller, or the television device, etc. The television video content can be a movie, TV program, sports, advertisement, etc. By capturing the preset data link tag of the television video data, analyzing the data link tag, the data link corresponding to the television video data is obtained. The user can access the directed network immediately through the data link to obtain the corresponding network resource data. This is very simple and convenient in operation. The network accessing to obtain network resource data corresponding to the television video can thus be controlled by one button.

The data link tag may be inserted into the television video beforehand by the television station or digital television operators or program producers. The data link tag records the corresponding data link of network resource data corresponding to the television video that is then transmitted to the television device to be displayed. By the method and system for controlling a television control device or the television control device, the user can access the network to obtain network resource data corresponding to the television video by one button.

Furthermore, after obtaining the data link, the data link may be opened directly to display the network resource data corresponding to the television video to the user. As a choice, the data link may be stored firstly, and the data link is not opened until an instruction from the user is received. In this way, the television program currently playing will not be interrupted when it is convenient for the user to access the data link to obtain the network resource data corresponding to the television video.

### BRIEF DESCRIPTION OF THE DRAWINGS

FIG. 1 is a flowchart of a method for controlling a television control device according to a first embodiment of the present invention;

FIG. 2 is a schematic two-dimensional code;

FIG. 3 is a schematic structure diagram of the method for controlling a television control device according to the first embodiment of the present invention.

### DETAILED DESCRIPTION OF THE PREFERRED EMBODIMENTS

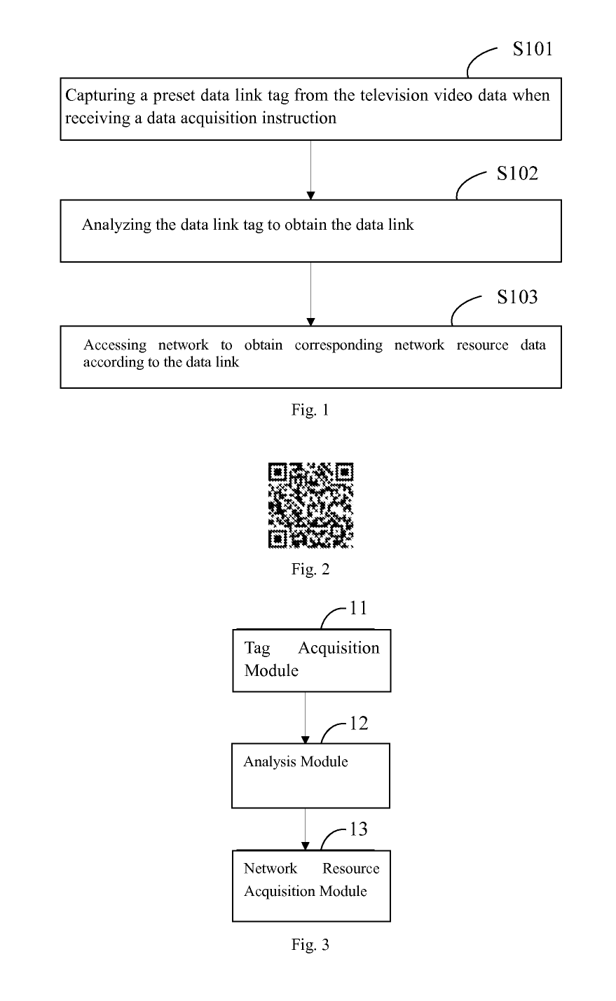

Referring to FIG. 1, it shows a flowchart of a method for controlling a television control device according to the first embodiment disclosed by the present invention.

The method for controlling a television control device includes the following steps:

S101, capturing a preset data link tag from the television video data when receiving a data acquisition instruction; wherein, the data link tag records the data link of network resource data corresponding to the television video data;

S102, analyzing the data link tag to obtain the data link; and

S103, accessing network to obtain corresponding network resource data according to the data link.

In step S101, a data acquisition instruction may be triggered through a specific button provided on the television remote controller or the television device. As a choice, an existing button on the television remote controller or the television device may be set to a specific triggering manner for the data acquisition instruction. For example, a network resource searching button may be provided on the television remote controller or the television device, or a long press, as a trigger of data acquisition instruction, may be set on the television remote controller or the television device.

The content of television video may be a movie, a TV program, sports, advertisement, etc., which is not limited.

The data link tag captured by Step S101 can be in various forms, and mainly for recording the corresponding data link of the network resource data corresponding to the television video data. The data link tag may be inserted into the television video beforehand by the television station or digital television operators or program producers. The data link tag records the corresponding data link of network resource data corresponding to the television video that is then transmitted to the users by the television station or digital television operators or program producers to be displayed. By the method for controlling a television control device, the user can access the network to obtain network resource data corresponding to the television video by one button.

As the method for controlling a television control device, two exemplary ways for obtaining the television video data are given in the present application.

One way may be: receiving input compressed digital television signals, and transforming the digital television signals into television video data of television broadcast device. This way may correspond to process mode of television signal conversion device like a set-top box, etc. Normally, the set-top box connects the digital television signal input and the television device. The set-top box receives compressed digital signals, then convert them into television video data (including simulation television or picture frame data of digital television), and output the data to the television device connected to the set-top box, which will be then displayed by the television device. Therefore, the set-top box can directly obtain the converted television video data.

The other way may be: receiving television video data currently displayed from television broadcast device directly. This way may correspond to external device like a TV box, etc., which can connect the television device to network. These devices do not convert the television signal, and therefore, there is no television signal passing through, and it is necessary to obtain television video data currently being displayed from the television broadcast device.

The entire television video data or part of the television video data may be captured in the step of capturing a data link tag of the television video data.

That is, an entire frame of image data of the television video may be captured and then the data link tag is captured on a specific position of the television image data. As a choice, a specific position of the television image data where the data link tag is located is captured directly.

Preferably, the network link tag is a two-dimensional code set at the edge of the image of the television video. Then, in step of S101, the two dimensional code preset at the edge of the image of the television video is captured. A two-dimensional code commonly used is shown in FIG. 2. The advantage of using the two-dimensional code is that the two-dimensional code is able to contain a large amount of data but occupy a space as small as 1.5 cm*1.5 cm, when the quality of television video will not be affected. A further advantage of using two-dimensional code is that the complete data can be obtained even though the image is not entirely captured.

Step S102, analyze the data link tag to obtain the data link.

In this step, the captured data link tag is analyzed. For example, if the data link tag is a two-dimensional code, then the two-dimensional code is decoded to obtain the data link recorded in the two-dimensional code.

The data link may be directed to an online video itself, or a list of online videos, or specific webpage, etc.

In the step of S103, obtain the corresponding network resource data, and transmit the network resource data to television device. According to the different type of the data link, in the step of obtaining corresponding network resource data, the operations of directly opening and displaying a network video, opening a list of online videos or specific webpage, etc. may be carried out.

For example, after the user presses the button to trigger the instruction, the television control device may directly open the data link, and obtain the network video data directed by the data link that is then transmitted to the television device to be displayed. One button triggers the automatic acquisition and displaying of network resource data corresponding to the television video, which is very straightforward and convenient.

As a preferred embodiment, in step S103 of obtaining the corresponding network resource data, the data link is stored at first, and after receiving triggered the data access instruction, the corresponding network resource data are obtained after accessing network according to the data link

The stored data link may be more than one, i.e. the user can trigger the data acquisition instruction many times, and each time after receiving the data acquisition instruction, the corresponding data links may be obtained by above steps S101 and S102, and each data link may be stored. When the user need to retrieve the data link, all the data links are sent to be displayed on a television device for the user to choose according to retrieval instruction. The user may choose to trigger one or more data link instructions, and the corresponding network resource data is obtained after accessing network according to the data link.

Through the above ways, there is no interruption to the television video currently playing, therefore, the corresponding data link may be opened at any time when desired, and the current television program will not be affected.

The method for controlling a television control device in the present invention are applicable for all types of television control devices, like a set-top box, a TV box, etc. If a user is interested in a television video when watching television, he may trigger the data acquisition instruction for acquiring the television video by a button on the television remote controller, or the television device, etc. The television video content can be a movie, TV program, sports, advertisement, etc. By capturing the preset data link tag of the television video data, analyzing the data link tag, the data link corresponding to the television video data is obtained. The user can access the directed network immediately through the data link to obtain the corresponding network resource data. This is very simple and convenient in operation. The network accessing to obtain network resource data corresponding to the television video can thus be controlled by one button.

As a preferred embodiment, the data link further records playing progress information of the television video.

In the step S102, when analyzing the data link tag, further obtain playing progress information of the television video.

In the step S103, when obtaining network resource data, further obtain network resource data corresponding to the playing progress information, according to the playing progress information.

For example, the data link tag pre-inserted in each frame of television image records the data link corresponding to the television video data and the playing progress information of the television video currently playing with respect to the entire television program. After the data link tag is analyzed, the data link of network resource data corresponding to the television video, and the playing progress information, are obtained. According to the data link and the playing progress information, the network resource data corresponding to playing progress information from network are obtained, and the network resource data is transmitted to the television device

The playing progress information may be inserted into the television signal beforehand by the digital television operators etc. In the step of obtaining network resource data corresponding to the playing progress information, only network resource data after the playing progress may be obtained. If the corresponding network video is displayed directly, the playing progress of the network video may be set according to the playing progress information.

For example, the television image currently playing on the television device is an image at four minutes and thirty seconds from the beginning of the entire program. At this moment, if the user presses the specific button to trigger the data acquisition instruction, then according to the method for controlling a television control device, the data link tag such as a two-dimensional code at the current television video data is captured and then decoded to obtain the data link corresponding to the network resource data and the playing progress information of television video, four minutes and thirty seconds. Then, open the data link and display the online video which the data link is directing to, and the playing progress is set to four minutes and thirty seconds. This allows the user to obtain an experience of watching television without interrupting.

Referring to FIG. 3, it is the schematic view of the method for controlling a television control device according to the first embodiment disclosed by the present invention.

The system for controlling a television control device includes:

a tag acquisition module 11, configured to capture a preset data link tag from the television video data when receiving a data acquisition instruction; wherein, the data link tag records the data link of network resource data corresponding to the television video data;

an analysis module 12, configured to analyze the data link tag to obtain the data link;

a network resource acquisition module 13, configured to access network to obtain corresponding network resource data according to the data link.

The tag acquisition module 11 may receive a data acquisition instruction triggered by the user through a specific button provided on the television remote controller or the television device. As a choice, an existing button on the television remote controller or the television device may be set to a specific triggering manner for the data acquisition instruction triggered by the user. For example, a network resource searching button may be provided on the television remote controller or the television device, or a long press, as a trigger of data acquisition instruction, may be set on the television remote controller or the television device.

The content of television video may be a movie, a TV program, sports, advertisement, etc., which is not limited.

The data link tag captured by tag acquisition module 11 can be in various forms of preset data tags, and mainly for recording the corresponding data link of the network resource data corresponding to the television video. The data link tag may be inserted into the television video beforehand by the television station or digital television operators or program producers. The data link tag records the corresponding data link of network resource data corresponding to the television video that is then transmitted to the users by the television station or digital television operators or program producers to be displayed. By the system for controlling a television control device, the user can access the network to obtain network resource data corresponding to the television video by one button.

The system for controlling a television control device may further include a television signal transformation module (not shown).

The television signal transformation module may obtain the television video data in the two following ways.

One way may be: the television signal transformation module is configured to receive input compressed digital television signals, and transform the digital television signals into television video data of television broadcast device. This way corresponds to process mode of television signal conversion device like a set-top box, etc., usually the set-top box connects the digital television signal input and the television device, and the set-top box receives compressed digital signals, and converts them into television video data (including simulation television or picture frame data of digital television), and outputs the data to television device connected to a set-top box, which will be displayed by television device. Therefore, the set-top box can directly obtain the converted television video data.

Another way may be: the television signal transformation module is configured to receive television video data which are displayed presently from television broadcast device directly. This way may correspond to external device like a TV box etc., which can connect television device to network. These devices do not convert the television signal, and therefore, there is no television signal passing through, and they need to obtain television video data being displayed presently, from television broadcast device.

When the tag acquisition module 11 is capturing a data link tag of the television video data, the entire television video data or part of the television video data may be captured.

That is, by the tag acquisition module 11, an entire image of the television video may be captured and then the data link tag is captured on a specific position of the television image. Alternatively, a specific position of the television image where the data link tag is located is captured directly.

Preferably, the network link tag is a two-dimensional code set at the edge of the image of the television video. Then, in step of S101, the two-dimensional code preset at the edge of the image of the television video is captured. The two-dimensional code commonly used is shown in FIG. 2. The advantage of using the two-dimensional code is that the two-dimensional code is able to contain a large amount of data but occupy a space as small as 1.5 cm*1.5 cm, when the quality of television video will not be affected. A further advantage of using two-dimensional code is that the complete data can be obtained even though the image is not entirely captured.

The captured data link tag is analyzed by the analysis module 12, for example, if the data link tag is a two-dimensional code, then the two-dimensional code is decoded to obtain the data link recorded in the two-dimensional code.

The data link may be directed to an online video itself, or a list of online videos, or specific webpage, etc.

The network resource acquisition module 13 may obtain the corresponding network resource data by accessing network according to the data link, and transmit the network resource data to the television device. According to different types of the data links, in the step of obtaining corresponding network resource data, the operations of directly opening and displaying a network video, opening a list of online videos or specific webpage, etc. may be carried out by the network resource acquisition module 13.

For example, after the user presses the button to trigger the instruction, the network resource acquisition module 13 may directly open the data link, and obtain the network video data directed by the data link that is then transmitted to the television device to be displayed. One button may trigger the automatic acquisition and displaying of network resource data corresponding to the television video, which is very straightforward and convenient.

As a preferred embodiment, the network resource acquisition module 13 may store the obtained data link at first; and after receiving triggered the data access instruction, the corresponding network resource data may be obtained after accessing network according to the data link.

The stored data links may be more than one, i.e. the user may trigger the data extraction instruction many times, and each time after receiving the data acquisition instruction, the tag acquisition module 11 and the analysis module may obtain corresponding data links, and the network resource acquisition module 13 store each data link. When the user needs to retrieve the data link, the data links are sent to be displayed on the television device for the user to choose according to retrieval instruction. The user may choose to trigger one or many of the data link instructions, and the corresponding network resource data may be obtained after accessing network according to the data link.

Through the above ways, there is no interruption to the television video currently playing, therefore, the corresponding data link may be opened at any time when desired, and the current television program will not be affected.

The system for controlling a television control device in the present invention is applicable for various television control devices, like a set-top box, a TV box, etc. If a user is interested in a television video when watching television, he may trigger the data acquisition instruction for acquiring the television video by a button on the television remote controller, or the television device, etc. The television video content can be a movie, TV program, sports, advertisement, etc. By capturing the preset data link tag of the television video data, analyzing the data link tag, the data link corresponding to the television video data is obtained. The user can access the directed network immediately through the data link to obtain the corresponding network resource data. This is very simple and convenient in operation. The network accessing to obtain the network resource data corresponding to the television video can thus be controlled by one button.

As a preferred embodiment, the data link tag may further record playing progress information of the television video.

Then, the analysis module 12, when analyzing the data link tag, may further obtain playing progress information of the television video.

Furthermore, the network resource acquisition module 13 may further obtain network resource data corresponding to the playing progress information, according to the playing progress information.

For example, the data link tag pre-inserted in each frame of television image records the data link corresponding to the television video data and the playing progress information of the television video currently playing with respect to the entire television program. After the analysis module 12 analyzes the data link tag, the data link of network resource data corresponding to television video, and the playing progress information, may be obtained. According to the data link and the playing progress information, the network resource acquisition module 13 may obtain the network resource data corresponding to playing progress information from network, and transmit the network resource data to the television device.

The playing progress information may be inserted into the television signal beforehand by the digital television operators, etc. In the step of obtaining network resource data corresponding to the playing progress information by the network resource acquisition module 13, it may only obtain network resource data after the playing progress. If the corresponding network video is displayed directly, the playing progress of the network video may be set by the network resource acquisition module 13 according to the playing progress information.

For example, the television image currently playing on the television device is an image at four minutes and thirty seconds from the beginning of the entire program. At this moment, if the user presses the specific button to trigger the data acquisition instruction, then according to the system for controlling a television control device, the data link tag such as a two-dimensional code at the current television video data is captured and then decoded to obtain the data link corresponding to the network resource data and the playing progress information of television video, four minutes and thirty seconds. Then, open the data link and display the online video which the data link is directing to, and the playing progress is set to four minutes and thirty seconds. This allows the user to obtain an experience of watching television without interrupting.

The present invention further provides a physical television control device, which comprises the system for controlling a television control device disclosed in the present invention. The television control device may be a set-top box, or a TV box, etc., any control device of television device. The installation of the controlling system for controlling a television control device disclosed by the present invention, it is able to realize the method for controlling a television control device disclosed by the present invention.

It should be emphasized that the above-described embodiments of the present invention, are merely possible examples of implementations. Many variations and modifications may be made to the above-described embodiments of the invention without substantially departing from the spirit and principles of the invention. All such modifications and variations are intended to be included herein within the scope of this disclosure and the present invention and protected by the following claims.

What is claimed is:

1. A method for controlling a television control device, comprising the following steps:
capturing a preset data link tag from television video data when receiving a data acquisition instruction, the data link tag recording a data link of network resource data corresponding to the television video data;
analyzing the data link tag to obtain the data link; and
accessing network to obtain corresponding network resource data according to the data link.

2. The method of claim 1, further comprising:
receiving input compressed digital television signals, and transforming the digital television signals into the television video data of television broadcast device.

3. The method of claim 1, further comprising:
obtaining television video data currently playing from the television broadcast device directly.

4. The method of claim 1, wherein playing progress information of television video is recorded in the data link tag;
in the step of analyzing the data link tag to obtain the data link, the playing progress information of television video is further obtained; and
in the step of accessing network to obtain corresponding network resource data according to the data link, network resource data corresponding to the playing progress information is further obtained according to the playing progress information.

5. The method of claim 1, wherein the step of obtaining a preset data link tag from the television video data comprises: capturing a preset two-dimensional code at edge of an image of the television video; and
the step of analyzing the data link tag to obtain the data link comprises: decoding the captured two-dimensional code.

6. The method of claim 1, wherein according to the data link, the step of accessing network to obtain corresponding network resource data comprises:
storing the data link obtained; and
accessing network to obtain corresponding network resource data according to the data link, when receiving an instruction for triggering the data link.

7. A system for controlling a television control device, comprising:
a tag acquisition module, configured to capture a preset data link tag from the television video data when receiving a data acquisition instruction; wherein, the data link tag records the data link of network resource data corresponding to the television video data;
an analysis module, configured to analyze the data link tag and obtain the data link; and
a network resource acquisition module, configured to access network to obtain corresponding network resource data according to the data link.

8. The system of claim 7, further comprising:
a television signal transformation module, configured to receive input compressed digital television signals, and transform the digital television signals into television video data of television broadcast device.

9. The system of claim 7, further comprising:
a television video acquisition module, configured to obtain television video data currently playing from television broadcast device directly.

10. The system of claim 7, wherein:
the data link tag further records playing progress information of television video;
when the data link tag is analyzed by the analysis module, a playing progress information of the television video is further obtained; and
when the network resource acquisition module obtains network resource data, network resource data corresponding to the playing progress information is further obtained according to the playing progress information.

11. The system of claim 7, wherein the data link tag is a two-dimensional code set at a preset position of an edge of an image of the television video;
the tag acquisition module captures the two-dimensional code from the television video data; and
the analysis module decodes the captured the two-dimensional code to obtain the data link.

12. The system of claim 7, wherein the network resource acquisition module further stores the data link obtained, and when receiving an instruction for triggering the data link, accesses network to obtain corresponding network resource data according to the data link.

13. A television control device, comprising: a system for controlling a television control device of claim 7.
